(19) United States
(12) Patent Application Publication
(10) Pub. No.: US 2013/0149889 A1
(43) Pub. Date: Jun. 13, 2013

(54) Wall Receptacle Cord Latch

(71) Applicant: Richard A. Carmitchel, Bonner Springs, KS (US)

(72) Inventor: Richard A. Carmitchel, Bonner Springs, KS (US)

(21) Appl. No.: 13/316,180

(22) Filed: Dec. 9, 2011

(51) Int. Cl. H01R 13/62

(52) U.S. Cl. 439/373

(57) ABSTRACT

A cover plate for an electrical duplex receptacle has an opening or openings therein as required to permit insertion of male plugs into the respective receiving receptacles. A female receptacle component projects outwardly from the cover plate and receives a stud projecting from the body of an inserted plug to thereby lock the plug against withdrawal that would otherwise occur if sufficient force is applied to pull the plug out of the receptacle and cause a loss of power to connected electrical equipment and resulting interruption in the operation thereof.

This invention relates to a latch for securing an electrical cord to a wall receptacle to prevent inadvertent withdrawal of the cord which may extend to power tools, lights or other appliances during construction or repair of a home, building or other structure, for example, in order to prevent a power failure and the interruption of work.

### BACKGROUND OF THE INVENTION

Power tools used in the construction and repair of buildings and other structures are often connected by long electrical cords to an available wall receptacle and, therefore, are subject to power interruptions that are caused by accidental withdrawal of a plug from a remote wall receptacle that may be hidden from view. When this occurs the cable must be traced back to the wall receptacle, which may not be in immediate view from the work site. A delay is thus imposed causing down time and a stoppage in the progress of the job at hand until the power connection is restored. According, it is desirable to lock the plug to the wall receptacle but to do so automatically at the time that the plug is initially inserted, and in a manner such that the plug may be immediately withdrawn from the wall receptacle by one hand for insertion at a different location as the project at hand may demand.

### SUMMARY OF THE INVENTION

In an embodiment of the present invention a wall receptacle cord latch is provided on a cover plate for an electrical wall receptacle. A female latch component adjacent the outlet extends outwardly and receives a male latch member projecting from an inserted plug to prevent withdrawal of the plug from the wall receptacle until such time that the latch component is manually released. The outwardly projecting latch component may be integral with the cover plate or provided by a separate component secured to the front face of the existing wall receptacle cover plate. In either configuration the latch component receives a male stud on the plug and thus secures the plug against withdrawal.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a front view of a first embodiment of the cord latch of the present invention having upper and lower latches.

FIG. 2 is a side view of the cord latch of FIG. 1.

FIG. 3 is a top plan view of the cord latch of FIG. 1.

FIG. 4 is a frontal perspective view of the cord latch component of FIG. 1 secured to a cover plate of a duplex receptacle and shown securing a plug inserted into the lower receptacle.

FIG. 5 is a front view of a cover plate for a second embodiment having a ground fault interrupter and provided with spaced, upper and lower cord latches and a transverse bridge associated with the lower latch.

FIG. 6 is a side elevation of the cover plate and upper and lower cord latches of FIG. 5.

FIG. 7 is a top plan view of the second embodiment of FIG. 5.

FIG. 8 is a partial, frontal perspective view of a Ground Fault Interrupter receptacle showing a cover plate thereon having integral, outwardly extending latches for upper and lower plugs.

### DETAILED DESCRIPTION

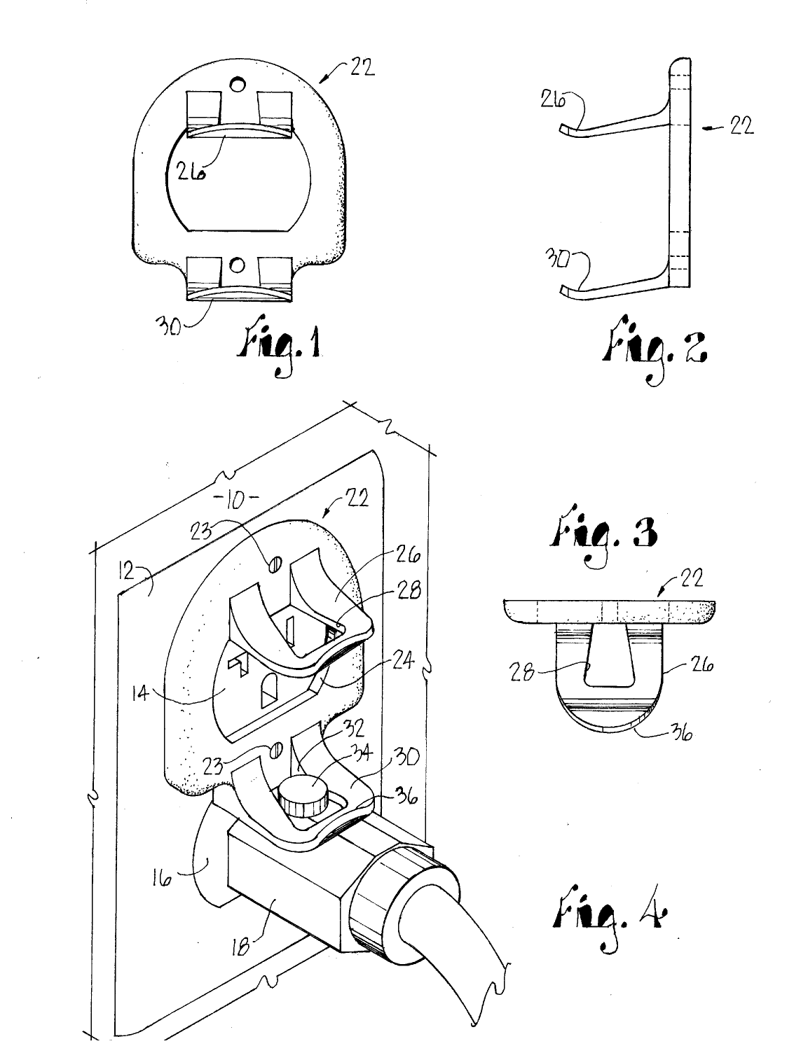

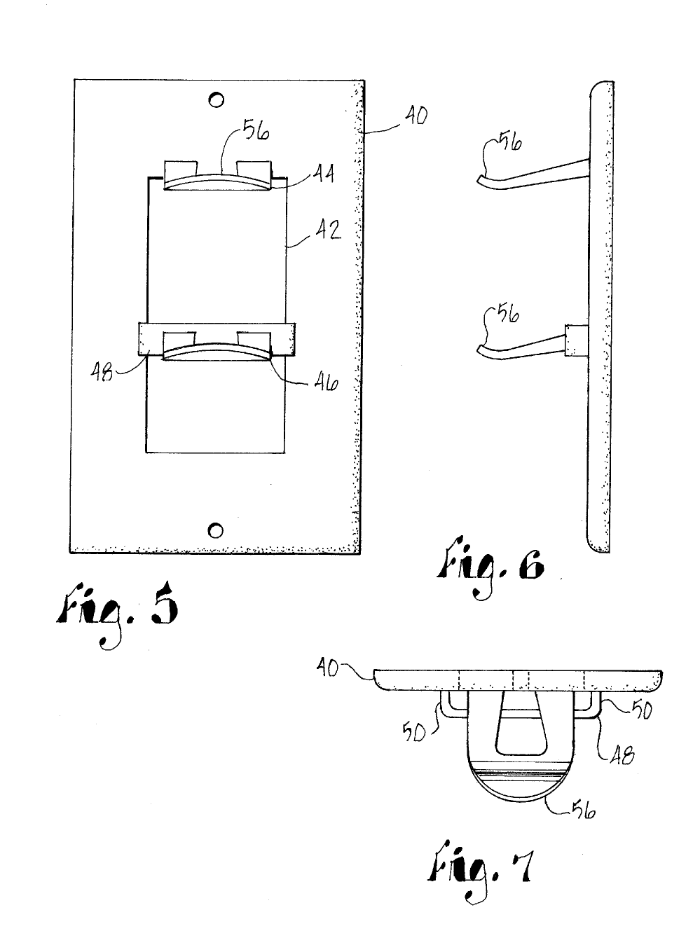

Referring initially to FIGS. 1-4, a conventional duplex receptacle 10 is partially shown in perspective in FIG. 4 having a duplex cover plate 12 thereon through which two receptacles may be accessed, an upper receptacle 14 into which a plug has not been inserted, and a lower receptacle 16 receiving a plug 18 on the end of an electrical cord 20. A receptacle adapter 22 surrounds the opening that provides access to receptacle 14 for insertion of a plug on an electrical cable (not shown in upper receptacle 14) that would extend therefrom, in the same manner as lower plug 18 and cord 20. Accordingly, the receptacle adapter 22 presents an opening 24 registering with the face of the upper receptacle 14 to permit insertion of a plug thereinto.

An outwardly extending, generally U-shaped female latch component 26 is secured and projects generally horizontally outwardly from the adapter 22 and thus presents a latch opening 28. Similarly, a lower female latch component 30 spaced below latch component 26 extends outwardly from the adapter body and is disposed and shaped in a like manner. The lower latch component 30 is shown having its latch opening 32 receiving a retaining pin or stud 34 projecting outwardly from a top side of plug 18 (FIG. 4). As may be appreciated, upon insertion of plug 18 into the lower socket 16, the latch component 30 flexes upon engagement of the stud 34 with an outer lip 36 thereby causing the latch component 30 to flex and then return to the position shown as the stud 34 is inserted fully within the opening 32. This is essentially a snap action that thus secures the plug 18 to prevent withdrawal of the plug from receptacle 16 that could occur if outward force is applied to the cord 20. It may be appreciated that without the cord latch of the present invention, stress on electrical cords can cause this to occur and thus, if not prevented, disconnect a power tool or tools and interrupt the operation of equipment thereby causing downtime and a stoppage in the progress of the work at hand. This is made worse in the frequent instance where the affected power tool is on a long power cord which must be traced back to the interrupted source.

FIGS. 1-3 show the receptacle adapter plate 22 alone (not mounted on cover plate 12 by screws 23). FIGS. 1, 2 and 3 are front, side and top views respectively of the adapter 22.

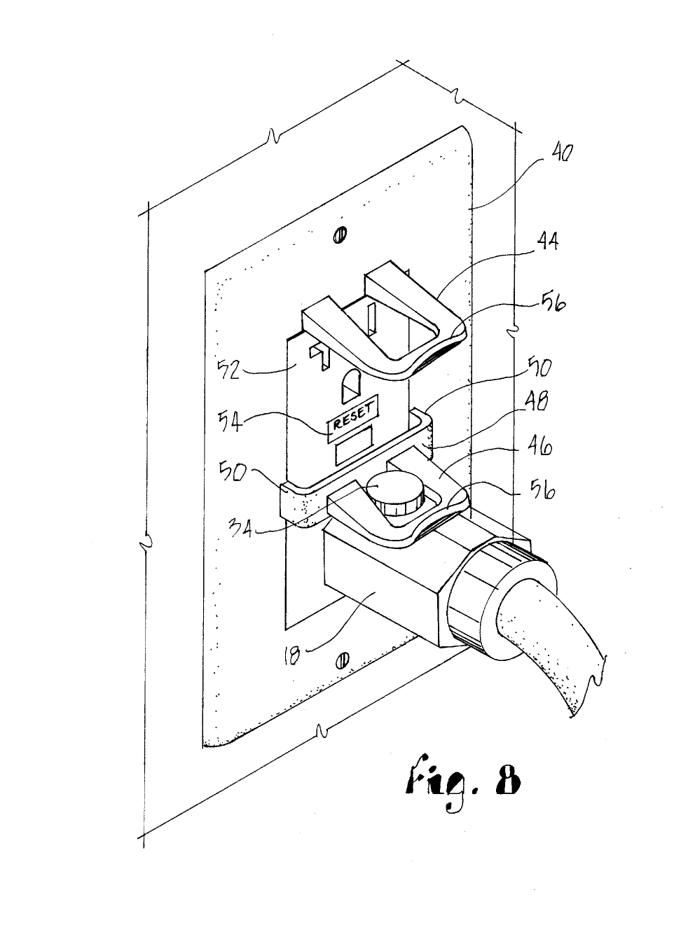

A second embodiment of the present invention is shown in FIGS. 5-8 wherein FIG. 5 is a frontal view of a cover plate 40 having an elongated, rectangular opening 42 therethrough, a female latch component 44 being secured to plate 40 and projecting outwardly therefrom at the upper end of opening 42 for the purpose of preventing withdrawal of an inserted plug (not shown) in the same manner as female latch component 26 in the embodiment of FIG. 4. The lower latch component 46 spaced therebelow, however, is mounted on a transverse bridge 48 which spans the width of opening 42 as is illustrated in FIG. 5. The latch component 46 projects to the front from bridge 48 (see FIG. 8) and receives the stud 34 on plug 18 (FIG. 8). The bridge 48 has inwardly turned ends 50 to space the bridge 48 from the upper receptacle 52 to permit access to a RESET button 54 in socket 52.

In view of the foregoing, it may be appreciated that in either embodiment the plug 18 is secured against inadvertent withdrawal, and in the embodiment of FIG. 8 the configuration provided by the outwardly spaced bridge 48 of cover plate 40 permits access to the RESET button 54. Also, insertion of plug 18 into engagement with either of the latch components 26, 30 or 44, 46 is facilitated by an upstanding, curved outer lip 36 (FIG. 1-4) or 56 (FIGS. 5-8) which flexes the respective female latch component upwardly during insertion to provide a snap lock. Also, the lip 36 or 56 facilitates withdrawal of the plug 18 by upward force applied by the user's thumbnail as the plug is grasped.

It should be understood that while certain forms of this invention have been illustrated and described, it is not limited thereto except insofar as such limitations are included in the following claims.

Having thus described the invention, what is claimed as new and desired to be secured by Letters Patent is:

1. A wall receptacle cord latch comprising:
a plug adapted to be secured to an end of an electrical cord and provided with prongs for insertion into a receptacle to provide an electrical connection,
a cover plate for said receptacle having an opening therein permitting said insertion of the plug into the receptacle,
a female latch component secured to said cover plate and projecting outwardly therefrom, and
a male latch member projecting from said plug and received by the female latch component to prevent withdrawal of the plug from the receptacle.

2. The wall receptacle cord latch as claimed in claim 1, further comprising a receptacle adapter on said cover plate, said female latch component projecting outwardly therefrom for receiving said male latch member to prevent said withdrawal of the plug.

3. The wall receptacle cord latch as claimed in claim 1, further comprising a receptacle adapter on said cover plate having an opening therein aligned with said receptacle, said female latch component projecting outwardly from said adapter and having an opening therein for receiving a shoulder presented by said male latch member to prevent said withdrawal of the plug.

4. The wall receptacle cord latch as claimed in claim 1, wherein said female latch component is integral with said plate and projects outwardly therefrom.

5. The wall receptacle cord latch as claimed in claim 1, wherein said female latch component has an outer lip for engaging a shoulder presented by said male latch member when the plug and the receptacle are mated.

6. The wall receptacle cord latch as claimed in claim 5, wherein said outer lip is disposed for engagement by the thumb of a user to facilitate withdrawal of the plug.

7. The wall receptacle cord latch as claimed in claim 1, wherein said female latch component has means for engaging said male latch member when the plug is inserted in the receptacle to thereby prevent withdrawal thereof.

8. The wall receptacle cord latch as claimed in claim 1, wherein said female latch component is resilient and has an outer lip for engaging said shoulder when said plug and the receptacle are mated to thereby prevent withdrawal thereof.

9. A duplex wall receptacle configuration and cord latch comprising:
a cover plate having an opening therein,
first and second spaced electrical receptacles received by said opening,
first and second spaced, outwardly projecting female latch components, said first latch component being attached to said cover plate and adapted to receive a first retaining pin on a first inserted power cord, and
a bridge spanning said opening, spaced from said first latch component and supporting said outwardly projecting second latch component,
said second latch component being adapted to receive a second retaining pin on a second power cord inserted in said second receptacle to prevent withdrawal thereof, whereby inadvertent withdrawal of either or both of said power cords is prevented.
